(19) United States
(12) Patent Application Publication
(10) Pub. No.: US 2020/0057773 A1
(43) Pub. Date: Feb. 20, 2020

(54) GENERATION AND USE OF NUMERIC IDENTIFIERS FOR ARBITRARY OBJECTS

(71) Applicant: Naviworld Limited, Limassol (CY)

(72) Inventors: Michael Gamzin, Limassol (CY); Michael Zelenin, Limassol (CY); Rostislav Yavorskiy, Moscow (RU)

(21) Appl. No.: 16/282,254

(22) Filed: Feb. 21, 2019

Related U.S. Application Data
(60) Provisional application No. 62/633,448, filed on Feb. 21, 2018.

(51) Int. Cl. G06F 16/38; G06F 16/31; G06F 16/33; G06F 16/185

(52) U.S. Cl. CPC G06F 16/381; G06F 16/185; G06F 16/3331; G06F 16/316

(57) ABSTRACT

A computer system implements novel identification algorithms to generate universal identifiers requested by distributed clients into unique numeric identifiers devoid of language-specific alphabetic characters. The identifiers may be used for indexing different objects in a database or databases. The computer system, working in cooperation with distributed clients, assists users who supply the unique numeric identifiers with finding information in the different systems regarding the identified objects.

### CROSS REFERENCE TO RELATED APPLICATIONS

This application claims priority pursuant to 35 U.S.C. § 119(e) to U.S. Provisional Application Ser. No. 62/633,448 filed Feb. 21, 2018, which is hereby incorporated by reference, in its entirety.

### FIELD

The present disclosure relates to the technical field of information identification, storage and retrieval systems, apparatus and methods.

### BACKGROUND

Global uniform resource identification has been addressed in certain prior publications, for example, “Universal Naming Scheme for Peer To Peer Resources”, U.S. Pat. No. 7,072,982; “System And Method for Unique Naming Of Resources In Networked Environments”, U.S. Pat. No. 7,533,141; “Method And System for a Unique Naming Scheme for Content Management Systems”, and US Patent Application Publ. No. 2006/0167841. These naming or identification schemes are intended for application by machines, and not for use by people. Therefore, it is difficult for people to make direct use of these identifying schemes.

People need human-readable indexing systems. For example, encyclopedias are useful for organizing enormous amounts of information and can be of great social important. Encyclopedias such as The Canon of Medicine by Avicenna, Encyclopedia Britannica or Wikipedia have had an enormous impact on human civilization. Usually an encyclopedia has a complete list of terms and notions in the field with brief description, but only very restricted number of real entities are mentioned there. Only a small minority of people, businesses, buildings or events are honored with a separate article.

Recent development of computing technologies makes it possible to aim at a new challenge: an encyclopedia for all real and virtual objects in the universe. Development of a universal digital encyclopedia has been addressed previously in several patents, for example: “Hierarchical Data Encyclopedia”, U.S. Pat. No. 5,274,806; “Encyclopedia of Software Components”, U.S. Pat. No. 5,632,022; “Electronic Encyclopedia”, U.S. Pat. No. 5,321,609, “Enhanced Electronic Encyclopedia”, U.S. Pat. No. 5,832,472; and “Processing and Publishing Digital Contents Including Encyclopedia” U.S. Pat. No. 8,990,219. The implementation of a universal encyclopedia would require a user-friendly universal identification scheme and technological solution to make it convenient and reliable.

It would be desirable, therefore, to develop new technologies for identifying any object of interest to people using identifiers that can be more easily remembered and used by people, that overcomes these and other limitations of the prior art.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a method for method for identifying objects in an arbitrary domain may include receiving, by at least one processor, a new address request with corresponding metadata from a client device for an object within a universal data storage system. The method may further include determining, by the at least one processor, a unique numeric identifier for the object that is not used as an identifier for any other object in the universal storage system based at least in part on the metadata. The determining may include determining the numeric identifier consisting essentially of a sequence of numeric digits, for example, using an algorithm based on the type of the object.

The method may further include providing, by the at least one processor, each numeric identifier in association with the corresponding metadata for the object to one or more computer servers for storing as a record in a digital data structure holding different numeric identifiers each associated with a different one of corresponding metadata; and serving, by the at least one processor over the computer network, the corresponding metadata for the object selected from the on-line data structure in response to at least one query containing the each numeric identifier.

In an additional aspect, the method may include serving a user interface application to at least one client device over a computer network, the user interface application configured to receive user input defining an object, obtaining corresponding metadata object according to a characteristic type at least in part from user input, sending the corresponding metadata to the at least one processor, and requesting assignment of a unique numeric identifier for the object.

In an aspect, the method may include assigning a value within a string of the sequence of numeric digits based on a determined object type for the object within a set of object types. The set of object types may include a temporary type that includes an active duration of the numeric identifier for the each object, and further comprising deactivating the numeric identifier for objects of the temporary type, after expiration of the active duration. In an alternative, or in addition, the set of object types further comprises a premium identifier type characterized by a numeric identifier shorter than numeric identifiers for other object types, corresponding to an object data type that includes a monetary value of the premium identifier type. In a related aspect, the method may include collecting, by the at least one processor, payment information in connection with the receiving the new address request of a premium identifier type.

The method may include storing, in the digital data structure, other information characterizing an object associated with the numeric identifier. For example, the processor may provide the record to a distributed public ledger (e.g., blockchain) system. The method may include coordinating, by the at least one processor, address assignment of two or more of the objects based on one or more of a hierarchical relationship or a peer relationship between the two or more of the objects.

The present identification system may be used for navigation and assignment of geographic addresses as described in U.S. Pat. No. 10,079,888 by the inventor hereof, as a Naviaddress identifier. Another possible application of the disclosed method is implementation of a distributed autonomous platform for an encyclopedia of all real and virtual objects, using a blockchain or other public ledger technology, or traditional hosted database. Metadata for each object in the may be stored as a database entry in association with the universal identifier.

An apparatus implementing a universal identification system may include a processor coupled to a memory and to a network interface. The processor may execute an application stored in the memory to perform operations of the method as summarized above, and connect, via the network interface, to a database of universal identifiers.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings, in which like reference characters are used to identify like elements correspondingly throughout the specification and drawings.

FIG. 1 is a block diagram illustrating aspects of a universal identification system as described herein.

FIG. 2 is a flow diagram illustrating aspects of a universal identification method as described herein.

FIG. 3 is a block diagram illustrating additional aspects of a universal identification system as described herein.

FIG. 4 is a table illustrating domains for numeric identifiers of different sizes.

FIGS. 5 and 6 are graphs illustrating hierarchical divisions within a domain of numeric identifiers.

FIG. 7 is a concept diagram illustrating a concept of premium identifiers in a domain of numeric identifiers.

FIGS. 8-11 are flow diagrams illustrating aspects of a method for generation and use of numeric identifiers for a universal database system.

FIG. 12 is a block diagram illustrating aspects of an apparatus for generation and use of numeric identifiers for a universal database system.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

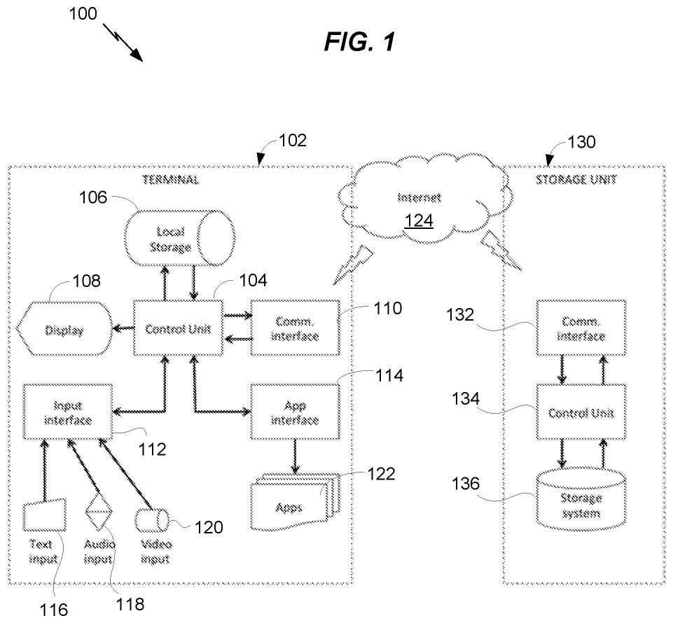

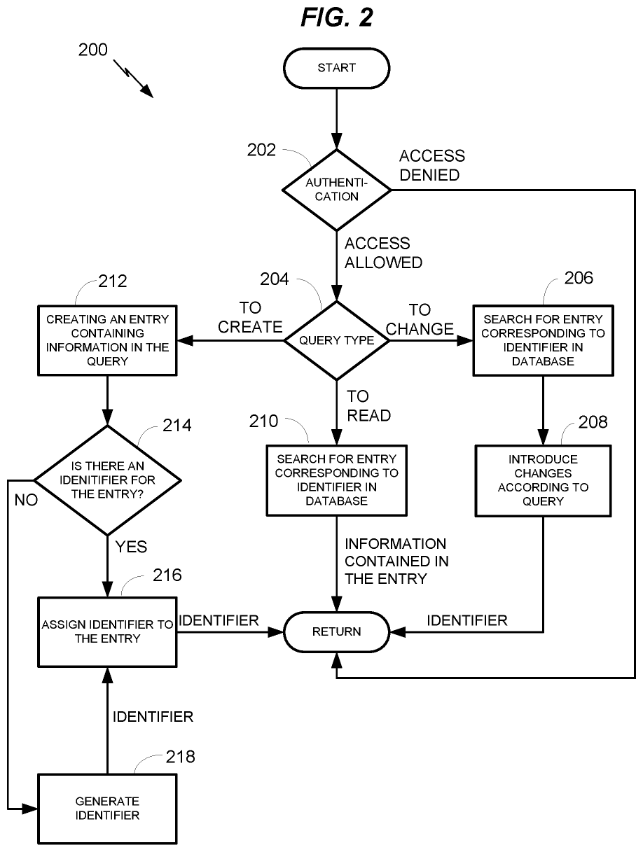

The technology is illustrated with explanatory drawings, where FIG. 1 shows a hardware system 100 for identifying objects in an arbitrary (universal) domain, and FIG. 2 shows aspect of a method 200 of a universal object identification system. The system 100 may include, for example, a unit to store metadata for an object being located by the system 100 (a storage unit 130) and a terminal 102, connected to it by communication channels, e.g., the Internet 124 and/or other communication network. The terminal 102 is implemented with a capability to make queries, to send queries to the storage unit 130, and to receive responses from the storage unit.

The storage unit 130 may include a subsystem to store object metadata (a storage subsystem 136) and a subsystem, connected to it, to control operations of the storage unit 130 (a control subsystem or unit 134). The storage unit 130 may sometimes be referred to herein as a “computer server,” “server,” “unit,” “node,” or similar terminology, and may include one or more discrete servers, which may operate independently or be organized using a cloud storage protocol, blockchain protocol, or a non-blockchain protocol for distributed storage. The storage subsystem 136 may contain metadata for identified objects arranged in the form of a database. The control subsystem 134 may be implemented with a capability to receive queries from the terminal 102 to the storage unit 130 via a communications interface component 132, and to send responses to the terminal 102, as well as to read and record the information in the storage subsystem 136 in accordance with the terminal queries.

The terminal 102 may be comprise a desktop computer or a portable computer, a portable electronic device, or another device enabling making queries and receiving information from the storage unit 130 via a communications interface 110. For example, the terminal 102 may comprise a smartphone, notepad computer, wrist-mounted computer, laptop computer, or other portable computing device including a communication interface 110 and display 108 or other user interface device. The terminal may further include an application software interface 114 using one or more applications 122. The terminal 102 may be implemented with a capability to enter the object metadata and control data in the form of a sequence of symbols and/or graphic images and/or signals of a different nature (sound, electromagnetic, etc.) via an input interface 112 to make a query to the storage unit 130. The input interface may be configured to receive text input 116 via a keyboard or touchscreen, audio input 118 via a microphone or other audio transducer, and video or other visual input 120 via a digital camera or the like.

The terminal may be connected to the storage unit by means of wire or wireless communication using the terminal software, for example, a web browser or another application via a communications interface 110 and Internet 124 or other network. The information received from the storage unit 130 may be displayed by the terminal using a display device 108 or may be transferred to another application and/or to another device by means of wire or wireless communication, for example, to implement the function of navigation and/or augmented reality.

The terminal 102 may comprise various components, for example, a processor or control unit 104 coupled to a memory or local storage 106. The local storage 106 may comprise a non-transitory computer-readable medium holding program instructions, that when executed by the control unit or processor 104, cause the terminal 102 to perform one or more operations of a method described herein, including but not limited to any one or more of the methods described in connection with FIGS. 2 or 8-11. It should be appreciated that other operations of these methods may be performed by the unit 130 or by a server in communication with the storage unit 130.

The storage unit 130 may be implemented on a terminal device and/or a remote server and/or a distributed (cloud or blockchain) service. The storage subsystem may be implemented in the form of any information local storage media, or as a cloud information storage system, as a blockchain or other cryptographically secured public ledger, or as a combination of a local and remote storage media (for example, for temporary storage of information downloaded from a remote server). The control subsystem 134 may be implemented as software, hardware or a hardware and software suite, enabling reading and changing the information contained in the storage subsystem in accordance with the incoming queries. The control unit 132 may be coupled to a memory (not shown) including a non-transitory computer-readable medium holding program instructions, that when executed by the control unit 132, cause the storage unit 130 to perform one or more operations of a method described herein, for example, any one or more of the methods described in connection with FIGS. 2, or 8-11. It should be appreciated that other operations of these methods may be performed by the terminal 102.

A method of object identification may be implemented by the system 100, for example, as follows. Information on the object may be stored as a database entry, e.g., in storage system 136. This information (metadata) is put into correspondence (e.g., 1-to-1 correspondence) with a unique universal numeric identifier, which may be expressed as a sequence of symbols represented using different means, including a standard alphabet, digits of different numerical systems, a graphical image (for example, a photograph, a fingerprint image, an iris or a retina image), or different encoding systems, for example, a barcode, a QR code, an RFID identification, a sequence of sounds, light or visual encoding. In certain embodiments, the identifier consists entirely of, or essentially of, numeric digits. Storing of the object metadata and correspondence with the identifier may be completed by the unity 130 in response to user input from the terminal 102. In an alternative, the unit 130 may store correspondence and object metadata automatically, without requiring any user input from the terminal 102. The object may be of any arbitrary nature capable of classification. Metadata concerning the object may include any data of interest.

The universal identifier corresponding to the object may be transferred to a user, and such transfer may be carried out in different modes. For example, the storage unit 130 may send the identifier to the terminal 102 by e-mail, by an SMS message, by generating paper output for mailing by post, by publishing in a publicly available medium (for example, TV channel, billboard, website, mark on map, etc.), by including as identification for geotags for photo and video materials, or any other available methods. Entities providing services or goods to a user may also receive the identifier. Such entities may include, for example, professional service providers, courier and post services, taxi companies and taxi traffic services, commercial companies, emergency services, security services, rescue services, and utility service providers.

Aspects of a method performed by a system 100 may include operations performed by a user terminal 102 or storage unit 130. For example, referring to FIG. 2, a method 200 for obtaining a universal identifier by a terminal 102 may include various operations generally directed towards querying the storage unit 130 and other operations, based on user input to the terminal 102. The query may be generated on the initiative of the user, or automatically, and may contain the universal identifier and/or information on the object. Then the query is transmitted to the storage unit 130 and received by the control subsystem 134 via the interface 132. To receive the object metadata, a user, who has received a universal identifier through some other channel or through the terminal 102, accesses the database via the terminal 102. To secure access to the database, the terminal 102 may require the user to pass a user authentication procedure 202. Based on the results of the user authentication procedure 202, the user may be granted with access to different query types 204, for example, via a menu or other suitable user interface. Different query types may include, for example: for creating a new universal identifier and its correspondence to an object that lacks such an identifier, for reading an existing universal identifier (including partial reading of entries) that uniquely corresponds to an object to be associated with metadata, and/or for changing metadata associated with an existing universal identifier (including creating new information entries and deleting the existing ones).

To execute a query type “to read,” the user enters the Universal identifier into the terminal unity 102. Upon receiving the universal identifier in a context indicating a “read” request, the terminal sends a query to the storage system 130. In response to receiving the query, the storage system 130 searches 210 for an entry corresponding to the universal identifier in its database. Upon retrieving the metadata corresponding to the universal identifier, and the storage unit 130 returns the object metadata from the database as a response to the user terminal 102, which outputs the metadata via a user output device (e.g., display 108). The search string for the query may consist of the universal identifier only, which the control subsystem 134 may use to identify the corresponding entry in the database of the storage system. Once the corresponding entry is found, the control subsystem generates a response containing the information on the entry found and sends this response to the terminal. If the database does not contain an entry corresponding to the universal identifier used in the query, the control subsystem 134 generates a response containing a message that the entry being searched is not found and sends it to the terminal.

In an aspect of query response generally, before sending a response to the terminal, the control subsystem 134 may check a privacy setting associated with the universal identifier or corresponding object metadata. The control subsystem 134 may limit distribution of the object metadata, based on the privacy setting. For example, the privacy setting may indicate that the information is authorized for access by all users, by a designated universal identifier “owner” only, or by a limited group of users (e.g., family members). The control subsystem then responds to the terminal 102 based on the privacy setting, for example, returning an error message without the object metadata if the privacy setting indicates that the terminal is not authorized, or returning the object metadata if the privacy setting indicates that the terminal is authorized to receive the information.

To execute a query type “to create,” the user enters object metadata 212 into the terminal unity 102. For example, a user may pick an object type from an interface of a guide program operating on the terminal, and a terminal application for the universal identifier function may obtain the object type from the guide program. Upon receiving the object type in a context indicating a “create” request, the terminal sends a query to the storage system 130. In response to receiving the query, if the database does not contain a universal identifier corresponding to the object type used in the query, the control subsystem 134 generates 218 a new universal identifier using one or more algorithms as described herein below, associates the newly created universal identifier with the object metadata in the database. For example, the control subsystem creates an entry in the database of the storage system and associates a unique universal identifier with it. If the database does contain a universal identifier corresponding to the object metadata used in the query, the control subsystem 134 provides (assigns) 216 the existing universal identifier for the object metadata in response to the object query. Once a new universal identifier is generated or an existing universal identifier retrieved, then the control system generates a response containing the universal identifier of the generated entry and sends it to the terminal. After receiving the response to the query, the terminal either displays the information contained in the response or sends this information to another application and/or device.

To execute a query type “to change,” the user enters a universal identifier into the terminal unity 102 with object metadata that it is desired to update. Upon receiving the universal identifier in a context indicating a “change” request, the terminal 102 sends a query to the storage system 130. In response to receiving the query, the storage system 130 searches 206 for an entry corresponding to the universal identifier in its database. Upon retrieving the object metadata corresponding to the universal identifier, and the storage unit 130 returns the corresponding information on the object from the database as a response to the user terminal 102, which outputs the information via a user output device (e.g., display 108). In an aspect, the terminal or storage unity may filter the returned metadata using a user-supplied or inferred criterion before supplying filtered metadata for output to the user. The control subsystem 134 may compare the object metadata received via the query and introduces 208 any changes into the database according to the query. Optionally, the control subsystem may create additional records to maintain a record of the prior object metadata associated with the universal identifier provided in the change query, for historical, recovery, or audit purposes. The control subsystem 134 generates a response containing a message that certain metadata for the universal identifier has been changed and sends the message to the terminal.

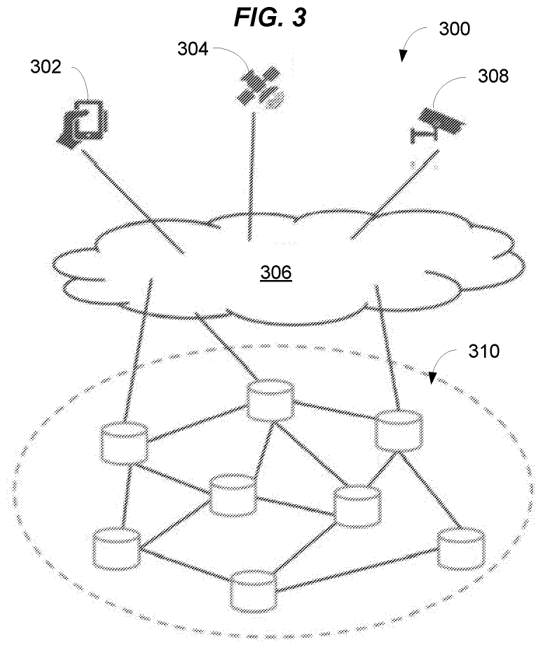

FIG. 3 shows a system 300 including networked storage nodes 310 (e.g., blockchain, cloud, or other distributed storage nodes) coupled to a terminal 302, a communication satellite 304, and an Internet of Things (IoT) device 308. The storage nodes 310 may be reached from any personal client device or other terminal 302, autonomous node (e.g., satellite 304) or other type of computer device 308 via an Internet infrastructure 306. The system 300 may be used to store, maintain and retrieve object metadata and associate universal identifiers stored on a decentralized distributed system of computer operated databases 310 implementing a blockchain, cloud, or other distributed architecture.

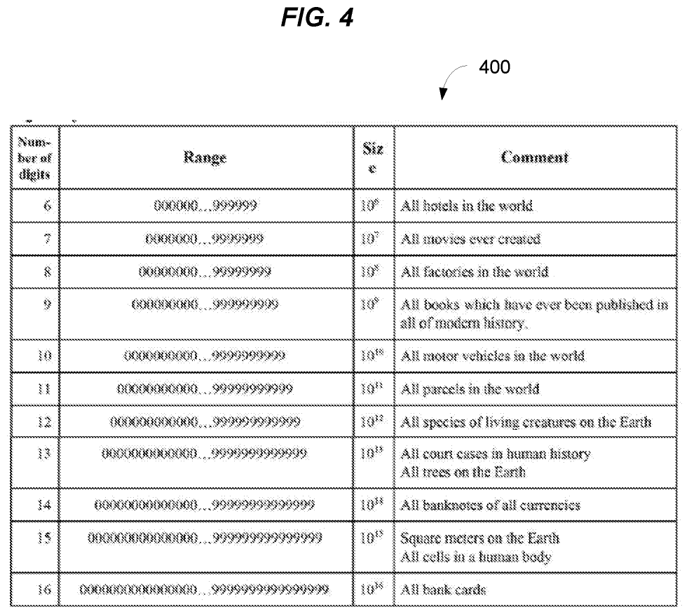

Universal identifiers may be arranged as a string of numeric digits, the length of which may depend on the domain of objects to be identified and described. FIG. 4 shows a table 400 correlating base-10 numeric universal identifiers from 6 to 16 digits in length to object domains of different size. Base-10 identifiers are used for ease of human comprehension. A universal identifier may consist of two parts, an identifier (ID) of the domain and individual object ID inside a domain. In both cases the set of ten digits {0 . . . 9} is used to construct the ID with auxiliary delimiters to distinguish between the different parts of the global identifier. Once the domain is fixed, a sequence of digits is enough to enumerate all objects in it.

The table 400 illustrates examples of different domains with a corresponding estimated size of the universal object ID needed to uniquely identify every object in the domain. For any reasonable domain the range of all digital sequences of length 16 is more than enough to provide each individual object with a unique identifier. By extending the string with several digits more the identifier will provide a unique identifier to every single atom in the universe or every memory cell in all existing computers.

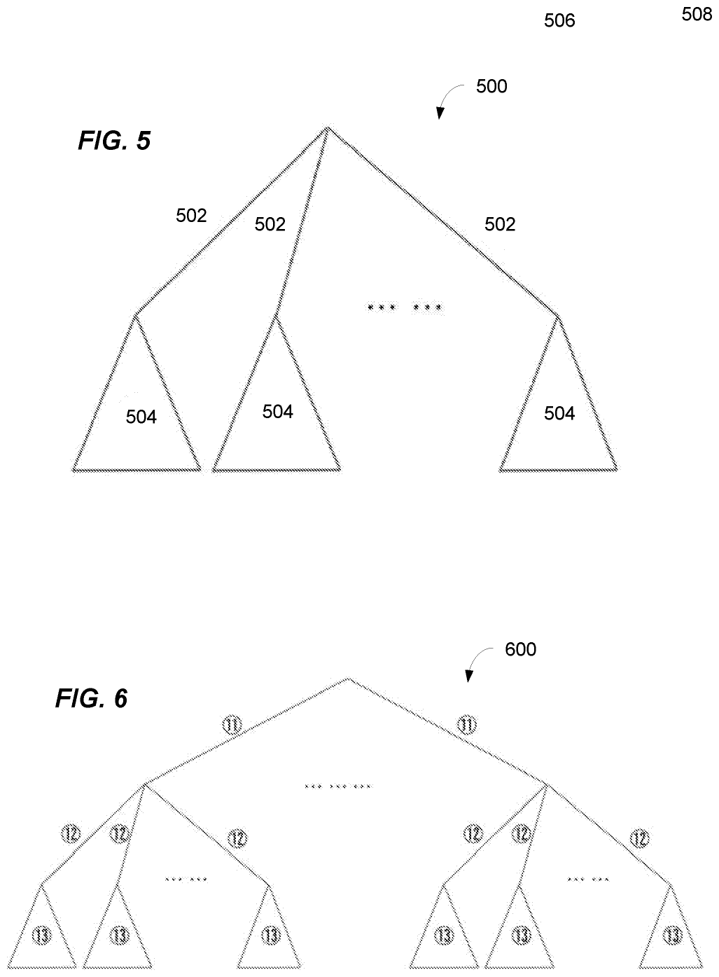

Referring to FIGS. 5 and 6, universal identifiers may be divided into sections for organizing hierarchies 500, 600 of classification within a domain, or hierarchies of domains. To distinguish different domains or parts of domains, numeric digits are used in a hierarchy from most significant section 502 to least significant section 504. For example, to organize telephone numbers three digits are used to designate an area code and seven digits indicate a telephone number within each area code. A complete object ID may consist of two or more parts, for example a section ID and an object ID inside the section. The logical structure is presented on FIG. 5. To specify a particular object a node may provide the section ID first and then the digital sequence assigned to the object within the domain.

In some cases, it is convenient to have domain sections 12 inside more general domain sections 11, that is a hierarchy of sections 600 as shown in FIG. 6. To specify an object in this case one should provide the outer section ID 11 first, then digital identifier of a section 12 inside the outer section, and finally the digital identifier 13 assigned to the object within the domain. A hierarchy may have any number of levels greater than two, but in all practical applications two levels is usually enough, for example, country code and area code are in fact sections for all installed fixed line phones, and the phone number is the digital identifier of the particular phone inside the area section. FIGS. 5-6 illustrate using the same logic to provide a universal identifier (or address) to every physical object in the universe as well as to all existing and future virtual objects in real domains and imaginary worlds.

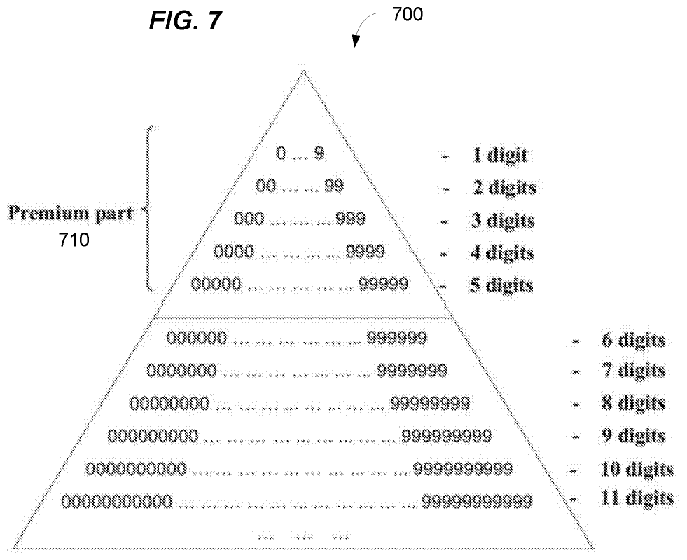

FIG. 7 illustrates the concept of premium identifiers 710 for restricted numbers of objects in a greater set of identifiers 700. The purpose of premium identifiers may include, for example, improving user experience and highlighting. The digital identification system described above assigns an identifier to any object. The identifier may contain ten to twenty digits, or even more some time, but this is not a problem unless the identifier is needed to be used frequently in a non-automated application. Few from billions of objects in a certain domain need to be communicated frequently and non-automatically. For them, a system and method may reserve short identifiers of length from 1 to 5 digits 710.

These short (or premium) identifiers 710 are much more simple and easier to remember, to spell out, to write on a business card, or communicate in any other way. They are intended to be used as aliases for objects with the maximal utility rate, so the assignment is done on competitive basis for a restricted period. An identification system may use an algorithm for auction or other allocation mechanism to distribute premium identifiers for deserving uses and discouraging hoarding.

After the successful assignment of a premium identifier the object will still retain the standard longer ID 700, so it could be accessed using the premium identifier, the standard identifier, or both. The system may assign the standard identifier to the object permanently, while assigning the premium identifier only for a defined period, for example, for a time specified by a contract. Premium identifiers may be owned by the system operator and used to fund operation of the database system using the universal identifiers. For example, users may trade utility tokens (e.g., as used in Ethereum ‘gas’) or temporary use rights to certain identifiers using an auction system, seniority system, or combination of these or other allocation schemes.

Now following the scheme described above any object in real or virtual world may be assigned a unique digital identifier. Next to the identifier a formal complete specification of the object should be given, which should be enough to distinguish it from other objects in this domain. After that a complete description with reference to other sources of information follows. So, each encyclopedia record may have three parts:

1) Digital ID of the object.

2) Complete formal specification of the object (coordinates for location or building, passport data for piece of art or vehicle etc.)

3) References to metadata and additional information about the object. In an aspect, the system may adjust the threshold number of digits for premium identifiers up or down for different domains. For example, premium personal identifiers may be six digits long while premium device identifiers are seven digits long and premium airport identifiers are three digits long. As noted, blockchain and related cryptographic protocols may be used to store the encyclopedia records in order to track all changes and updates of the information. In an aspect, management of premium identifiers may be implemented as a smart contract on blockchain infrastructure, for example using Ethereum or other Turing-complete network.

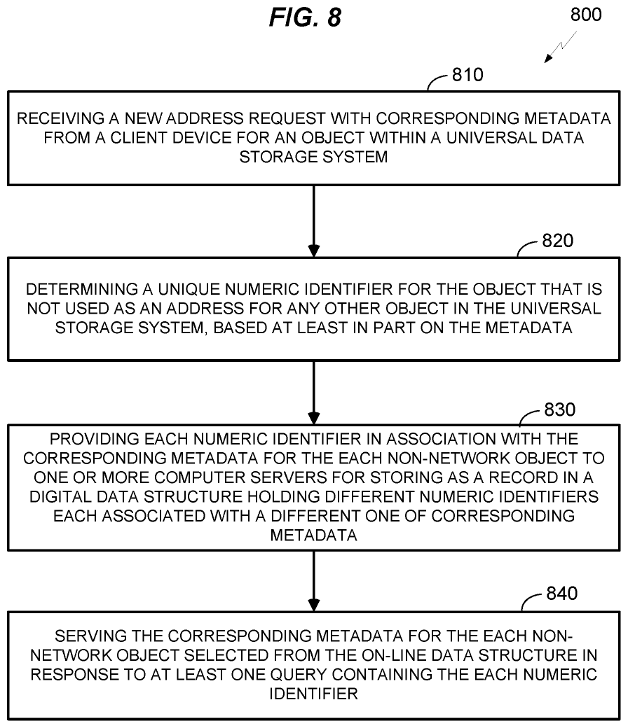

In view the foregoing, and by way of additional example, FIGS. 8-11 show aspects of a method 800 or methods for universal object identification, as may be performed by a system including at least a user terminal and storage unit as described herein. Referring to FIG. 8, the method 800 may include, at 810 by at least one processor, receiving a new address request with corresponding metadata from a client device for an object within a universal data storage system. For example, a user interface application may be configured to request assignment of a unique numeric identifier for the object. Transmission of the new object information in a message may automatically be construed as a request, or in the alternative, the client device may generate a separate request message or include separate request data in the object message. The request may be received by a storage node via a computer network, for example via the Internet, or via a combination of the Internet and a wireless telephone network.

The method 800 may further include, at 820, determining, by the at least one processor, a unique numeric identifier for the object that is not used as an identifier for any other object in the universal storage system, based at least in part on the metadata. Determination of the identifier may include execution of an algorithm for generating an entirely numeric identifier as disclosed elsewhere herein. The identifier may be or may include, without limitation, any one or more of the various universal numeric identifier types described herein above.

The method 800 may further include, at 830, providing by the at least one processor each numeric identifier in association with the corresponding metadata for the object to one or more computer servers for storing as a record in a digital data structure holding different numeric identifiers each associated with a different one of corresponding metadata. The digital data structure may be, or may include, a relational database hosted by a server or cloud server. The relational database may relate each of the different numeric identifiers to a different one of corresponding object metadata (one-to-one relationship). In an alternative, the database may be served by an open or restricted community of nodes operating a protocol for an immutable ledger, for example, an Ethereum network.

The method 800 may further include, at 840, serving, by the at least one processor over the computer network, the corresponding metadata for the object selected from the on-line data structure in response to at least one query containing the each numeric identifier. The query and its response may be transmitted over the computer network, for example, via the Internet, or via a combination of the Internet and a wireless telephone network.

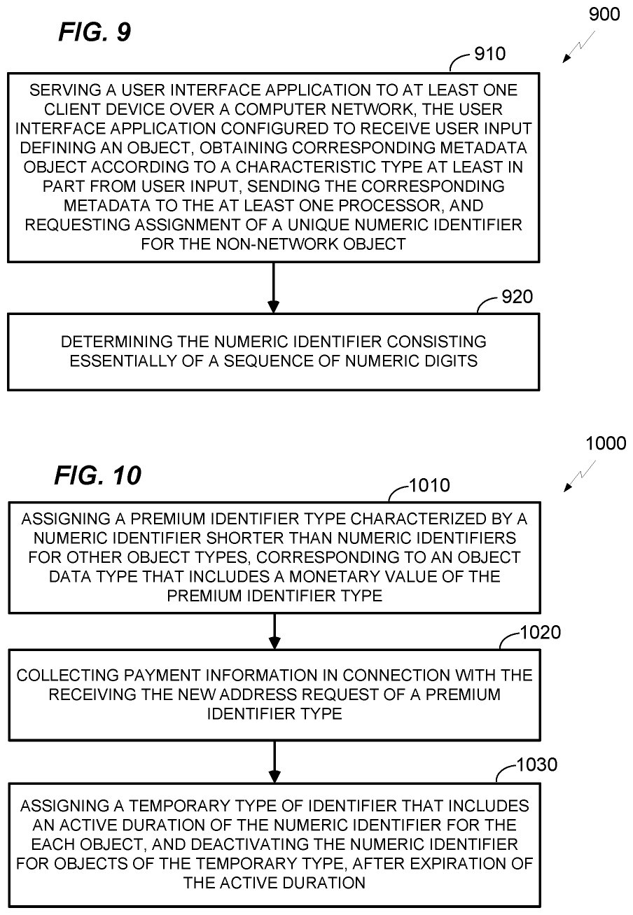

The method 800 may include any one or more of additional operations 900, 1000 or 1100 shown in FIGS. 9-11, in any operable order. Each of these additional operations is not necessarily performed in every embodiment of the method, and the presence of any one of the operations 900, 1000 or 1100 does not necessarily require that any other of these additional operations also be performed.

Referring to FIG. 9, the method 800 may further include, at 910, serving a user interface application to at least one client device over a computer network, the user interface application configured to receive user input defining an object, obtaining corresponding metadata object according to a characteristic type at least in part from user input, sending the corresponding metadata to the at least one processor, and requesting assignment of a unique numeric identifier for the object. For example, the application may be transmitted from a server to the client device as a file over the Internet, or over a combination of the Internet and a wireless telephone network. The user interface application may be configured to receive user input via the client device, for example, from a touchscreen that presents a graphical user interface and receives touch input selecting a type of a object from a set of object types each characterized by a different hierarchy section. The user interface application may further be configured for obtaining corresponding metadata for the object according at least in part from user input. For example, the user interface application may include instructions for causing the recipient client device to present one or more user interface screens via which a user of the device may enter the object metadata, such as, for example, a postal address for a postal-addressed location type, longitude and latitude coordinates for a geographic location type, name, birthdate, birth location and biometric data for a personal identifier, and so forth. The user interface application may further be configured for sending the corresponding metadata to the at least one computer server, for example, by generating a message including the information and transmitting it via the computer network to a designated server address for receiving new object metadata. Means for distributing the user interface application may include at least one processor coupled to a memory and to a network interface, the processor executing an algorithm based on program instructions stored in the memory. Such algorithm may include a sequence of more detailed operations, for example, receiving a destination address, retrieving the user interface address from a data store as an executable data package configured for installation on the requesting user terminal, and sending the data package to the user terminal.

The method 800 may further include, at 920, determining the numeric identifier consisting of, or consisting essentially of, a sequence of numeric digits. In an aspect of the method 800, the user interface application may identify the set of object types as described in more detail herein above, including without limitation any of the various universal identifier types described herein above.

Referring to FIG. 10, the at least one processor may identify a set of object types including a temporary premium type corresponding to an object metadata type that includes an active duration of the numeric identifier for the object. For example, the active duration may be a definite period such as, for example, one hour, one day, one week or one month, or an indefinite period such as, for example, while an identified object (e.g., a vessel or package) is in transit. In such embodiments, the method 800 may include at 1010, assigning a premium identifier type characterized by a numeric identifier shorter than numeric identifiers for other objects of the same type. In an aspect, the premium identifier may correspond to an object data type that includes a monetary value for the premium identifier type, expressed in fiat or cryptographic tokens. The method 800 may include at 1020, collecting payment information in connection with the receiving the new address request of a premium identifier type. The method 800 may include at 1030, deactivating the numeric identifier for objects of the temporary type, after expiration of the active duration. After the numeric identifier is deactivated, it may be reused to indicate a different temporary location.

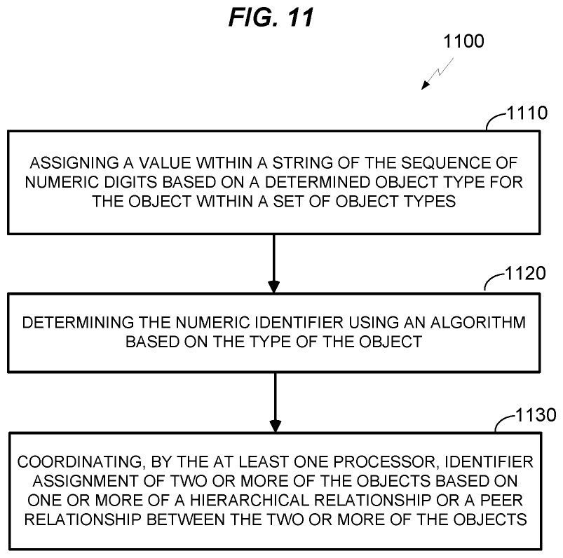

Referring to FIG. 11, the method 800 may further include, at 1110, assigning a value within a string of the sequence of numeric digits based on a determined object type for the object within a set of object types. In an aspect, the method 800 may further include, at 1120, determining the numeric identifier using an algorithm based on the type of the object. For example, the method may include determining the numeric identifier by executing an algorithm that minimizes Levenshtein distance between the numeric identifier and other object identifying information, e.g., an address. In another aspect the method 800 may further include, at 1130, coordinating, by the at least one processor, identifier assignment of two or more of the objects based on one or more of a hierarchical relationship or a peer relationship between the two or more of the objects. The processor may assign sections of an identifier to denote a hierarchical classification scheme as described in connection with FIGS. 5-6 above. In such embodiments, the method may further include deriving, by the at least one processor, one or more parts of the identifier for the object for locating the object within a classification hierarchy, based on position and number of digits within the identifier.

By way of further example, the method 800 may further include transmitting a portion of the on-line data structure to the client device for storage in a memory thereof, the portion including multiple ones of the different numeric identifiers pertaining to a lesser subset of identified objects. The client device may locally store part of the database and use it to response to user inquiries without needing to connect to the server. For example, a user may periodically download and store the latest portion of the object metadata for her city of residence, or a city she is visiting. The client device may first search its locally cached copy of the data when responding to an object inquiry and connect to the network only if the object identifier is not present in the local cache. This may enable faster response and relieve network load, for example, by transmitting database information to the local client at low-traffic times.

The method 800 may further include storing, in the digital data structure, other information characterizing an object associated with the numeric identifier. For example, the client device may provide descriptive information in the form of (for example) text, photographs, web links, or video, in connection with an object for which a numeric identifier is requested. The server may store the descriptive information in a field of the database that is related to the numeric identifier. In an alternative, the server may automatically search the Internet and pull information into its database that describes or supplements metadata for an identified object.

The method 800 may further include identifying a set of object types including a virtual object type corresponding to an object metadata type that includes an identification of a virtual modeled environment in which the object exists. The method 800 may further include identifying one or more of a set of object types including a mutable-relationships type object type that includes tracking data for tracking movement or other relationship changes (e.g., changes in location or relative standing) between the object and other objects.

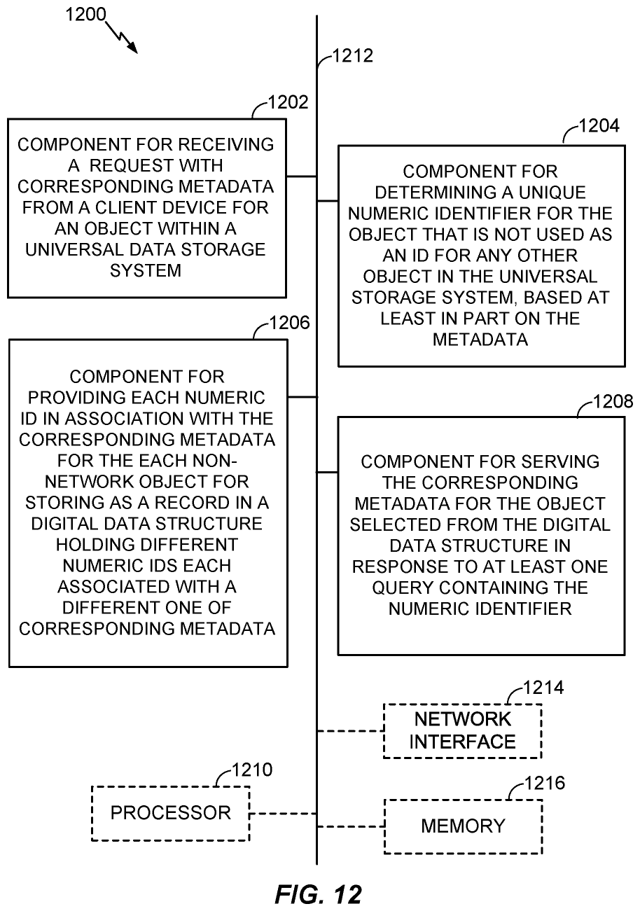

FIG. 12 is a conceptual block diagram illustrating components of an apparatus or system 1200 for providing and managing a universal identifier. The apparatus or system 1200 may include additional or more detailed components as described herein. For example, the processor 1210 and memory 1216 may contain an instantiation of a storage system as described herein above, including the more detailed components pointed out in FIG. 1 and other ancillary components (e.g., a user terminal). As depicted, the apparatus or system 1200 may include functional blocks that can represent functions implemented by a processor, software, or combination thereof (e.g., firmware).

As illustrated in FIG. 12, the apparatus or system 1200 may comprise an electrical component 1202 for receiving a new identifier request with corresponding metadata from a client device for an object within a universal data storage system. The component 1203 may be, or may include, a means for said receiving. Said means may include the processor 1210 coupled to the memory 1216, and to the network interface 1214, the processor executing an algorithm based on program instructions stored in the memory. Such algorithm may include a sequence of more detailed operations, for example, as described herein above in connection with FIG. 2.

The apparatus or system 1200 may comprise an electrical component 1204 for determining a unique numeric identifier for the object that is not used as an identifier for any other object in the universal storage system, based at least in part on the metadata. The component 1204 may be, or may include, a means for said determining. Said means may include the processor 1210 coupled to the memory 1216, and to the network interface 1214, the processor executing an algorithm based on program instructions stored in the memory. Such algorithm may include a sequence of more detailed operations, for example, responding to queries from user terminals, generating or retrieving a unique numeric identifier for each object as described in more detail herein above, and sending a responsive numeric identifier over the computer network in response to each of the queries.

The apparatus or system 1200 may comprise an electrical component 1206 for providing each numeric identifier in association with the corresponding metadata for the object to one or more computer servers for storing as a record in a digital data structure holding different numeric identifiers each associated with a different one of corresponding metadata. The component 1206 may be, or may include, a means for said providing. Said means may include the processor 1210 coupled to the memory 1216, and to the network interface 1214, the processor executing an algorithm based on program instructions stored in the memory. Such algorithm may include a sequence of more detailed operations, for example, executing a relational database application or blockchain smart contract, and generating write operations containing the different numeric identifiers for corresponding object metadata.

The apparatus or system 1200 may comprise an electrical component 1208 for serving over a computer network the corresponding metadata for the object selected from the on-line data structure in response to at least one query containing the each numeric identifier. The component 1208 may be, or may include, a means for said serving. Said means may include the processor 1210 coupled to the memory 1216, and to the network interface 1214, the processor executing an algorithm based on program instructions stored in the memory. Such algorithm may include a sequence of more detailed operations, for example, receiving queries each including a numeric universal identifier associated with respective network address sources, holding network addresses for the respective sources in a register in association with a query identifier; retrieving object metadata based on the numeric universal identifiers from a database, and sending the metadata in response to the queries based on the information stored in the register.

The apparatus 1200 may optionally include a processor module 1210 having at least one processor, in the case of the apparatus 1200 configured as a one or more controllers for a server (storage unit) in communication with the user terminal over a network interface. The processor 1210, in such case, may be in operative communication with the modules 1202-1208 via a bus 1212 or similar communication coupling. The processor 1210 may effect initiation and scheduling of the processes or functions performed by electrical components 1202-1208.

In related aspects, the apparatus 1200 may include a network interface module 1214 operable for communicating with one or more user terminals over a computer network. In further related aspects, the apparatus 1200 may optionally include a module for storing information, such as, for example, a memory device/module 1216. The computer readable medium or the memory module 1216 may be operatively coupled to the other components of the apparatus 1200 via the bus 1212 or the like. The memory module 1216 may be adapted to store computer readable instructions and data for effecting the processes and behavior of the modules 1202-1208, and subcomponents thereof, or the processor 1210, or the method 800 and one or more of the additional operations 900-1100 disclosed herein. The memory module 1216 may retain instructions for executing functions associated with the modules 1202-1208. While shown as being external to the memory 1216, it is to be understood that the modules 1202-1208 can exist within the memory 1216.

In view of the exemplary systems described herein above, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include several components, modules, and the like. It is to be understood and appreciated that the various systems may include additional components, modules, etc. and/or may not include all the components, modules, etc. discussed in connection with the figures. A combination of these approaches may also be used. Certain aspects disclosed herein may be performed using computing devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with certain aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed aspects. Non-transitory computer readable media can include but are not limited to magnetic storage devices (e.g., hard disk, floppy disk, magnetic strips . . . ), optical disks (e.g., compact disk (CD), digital versatile disk (DVD), Blu-ray™ . . . ), smart cards, and flash memory devices (e.g., card, stick). Those skilled in the art will recognize many modifications may be made to this configuration without departing from the scope of the disclosed aspects.

The previous description of the disclosed aspects is provided to enable any person skilled in the art to make or use the present disclosure. The examples provided above are to be regarded in an illustrative sense rather than a restrictive sense. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A method for identifying objects in an arbitrary domain, the method comprising:
receiving, by at least one processor, a new address request with corresponding metadata from a client device for an object within a universal data storage system;
determining, by the at least one processor, a unique numeric identifier for the object that is not used as an identifier for any other object in the universal storage system based at least in part on the metadata;
providing, by the at least one processor, each numeric identifier in association with the corresponding metadata for the object to one or more computer servers for storing as a record in a digital data structure holding different numeric identifiers each associated with a different one of corresponding metadata; and
serving, by the at least one processor over the computer network, the corresponding metadata for the object selected from the on-line data structure in response to at least one query containing the each numeric identifier.

2. The method of claim 1, further comprising serving a user interface application to at least one client device over a computer network, the user interface application configured to receive user input defining an object, obtaining corresponding metadatan object according to a characteristic type at least in part from user input, sending the corresponding metadata to the at least one processor, and requesting assignment of a unique numeric identifier for the object.

3. The method of claim 1, further comprising wherein the determining comprises determining the numeric identifier consisting essentially of a sequence of numeric digits.

4. The method of claim 3, further comprising assigning a value within a string of the sequence of numeric digits based on a determined object type for the object within a set of object types.

5. The method of claim 4, wherein the set of object types further comprises a temporary type that includes an active duration of the numeric identifier for the each object, and further comprising deactivating the numeric identifier for objects of the temporary type, after expiration of the active duration.

6. The method of claim 4, wherein the set of object types further comprises a premium identifier type characterized by a numeric identifier shorter than numeric identifiers for other object types, corresponding to an object data type that includes a monetary value of the premium identifier type.

7. The method of claim 6, further comprising collecting, by the at least one processor, payment information in connection with the receiving the new address request of a premium identifier type.

8. The method of claim 4, wherein the determining further comprises determining the numeric identifier using an algorithm based on the type of the object.

9. The method of claim 4, further comprising storing, in the digital data structure, other information characterizing an object associated with the numeric identifier.

10. The method of claim 1, further comprising coordinating, by the at least one processor, address assignment of two or more of the objects based on one or more of a hierarchical relationship or a peer relationship between the two or more of the objects.

11. An apparatus for identifying objects in an arbitrary domain, comprising:
a processor, a memory coupled to the processor, and a network interface device coupled to the processor, wherein the memory holds instructions that when executed by the processor, cause the apparatus to perform the operations of:
receiving a new address request with corresponding metadata from a client device for an object within a universal data storage system;
determining a unique numeric identifier for the object that is not used as an identifier for any other object in the universal storage system, based at least in part on the metadata;
providing each numeric identifier in association with the corresponding metadata for the object to one or more computer servers for storing as a record in a digital data structure holding different numeric identifiers each associated with a different one of corresponding metadata; and
serving the corresponding metadata for the object selected from the on-line data structure in response to at least one query containing the each numeric identifier.

12. The apparatus of claim 11, wherein the memory holds further instructions for serving a user interface application to at least one client device over a computer network, the user interface application configured to receive user input defining an object, obtaining corresponding metadatan object according to a characteristic type at least in part from user input, sending the corresponding metadata to the at least one processor, and requesting assignment of a unique numeric identifier for the object.

13. The apparatus of claim 11, wherein the memory holds further instructions for determining the numeric identifier consisting essentially of a sequence of numeric digits.

14. The apparatus of claim 13, wherein the memory holds further instructions for assigning a value within a string of the sequence of numeric digits based on a determined object type for the object within a set of object types.

15. The apparatus of claim 14, wherein the memory holds further instructions for recognizing the set of object types further comprising a temporary type that includes an active duration of the numeric identifier for the each object, and deactivating the numeric identifier for objects of the temporary type, after expiration of the active duration.

16. The apparatus of claim 14, wherein the memory holds further instructions for recognizing the set of object types further comprising a premium identifier type characterized by a numeric identifier shorter than numeric identifiers for other object types, corresponding to an object data type that includes a monetary value of the premium identifier type.

17. The apparatus of claim 16, wherein the memory holds further instructions for collecting payment information in connection with the receiving the new address request of a premium identifier type.

18. The apparatus of claim 14, wherein the memory holds further instructions for determining the numeric identifier using an algorithm based on the type of the object.

19. The apparatus of claim 14, wherein the memory holds further instructions for coordinating, by the at least one processor, identifier assignment of two or more of the objects based on one or more of a hierarchical relationship or a peer relationship between the two or more of the objects.

20. A navigation apparatus for identifying objects in an arbitrary domain, comprising:
means for receiving a new address request with corresponding metadata from a client device for an object within a universal data storage system;
means for determining a unique numeric identifier for the object that is not used as an identifier for any other object in the universal storage system, based at least in part on the metadata;
means for providing each numeric identifier in association with the corresponding metadata for the object to one or more computer servers for storing as a record in a digital data structure holding different numeric identifiers each associated with a different one of corresponding metadata; and
means for serving the corresponding metadata for the object selected from the on-line data structure in response to at least one query containing the each numeric identifier.
